(19) United States
(12) Patent Application Publication
(10) Pub. No.: US 2013/0144983 A1
(43) Pub. Date: Jun. 6, 2013

(54) METHODS AND APPARATUSES FOR CDN SHAPING

(71) Applicant: Digitial Keystone, Inc., Mountain View, CA (US)

(72) Inventors: Luc Vantalon, Sunnyvale, CA (US); Paolo Siccardo, Los Altos, CA (US)

(73) Assignee: DIGITIAL KEYSTONE, INC., Mountain View, CA (US)

(21) Appl. No.: 13/684,043

(22) Filed: Nov. 21, 2012

Related U.S. Application Data
(63) Continuation-in-part of application No. 13/408,943, filed on Feb. 29, 2012.
(60) Provisional application No. 61/605,164, filed on Feb. 29, 2012.
(60) Provisional application No. 61/565,876, filed on Dec. 1, 2011.

(51) Int. Cl. H04L 29/08

(52) U.S. Cl. CPC H04L 67/26
USPC 709/219

(57) ABSTRACT

The distribution of media content within a subscriber domain is controlled at a server. A subscriber domain is defined as an association including one or more subscriber devices, which can access content from one or more gateways, using one or more content distribution networks. The server is performing a CDN Shaping Service (CSS) for optimizing the operations of the content distribution networks based on domain analytics data. The domain analytics data is computed with previously acquired domain monitoring data.

### CROSS-REFERENCE TO RELATED APPLICATIONS

The present application claims the benefit of and is related to U.S. provisional patent application No. 61/565,876, filed on Dec. 1, 2011, entitled “Methods and Apparatuses for Domain Management” by Luc Vantalon and Paolo Siccardo and this present application is a continuation-in-part of U.S. patent application Ser. No. 13/408,943 (Attorney docket number 6517P014) filed on Feb. 29, 2012, entitled “Methods and Apparatuses for Domain Management” by Luc Vantalon and Paolo Siccardo. Both of these applications are incorporated by reference herein in their entirety. The U.S. provisional patent application No. 61/565,876 and U.S. patent application Ser. No. 13/408,943 (Attorney docket number 6517P014) are assigned to the same assignee as the present patent application. This present application also claims the benefit of U.S. provisional patent application No. 61/605,164, filed on Feb. 29, 2012, and this provisional application is incorporated by reference herein in its entirety, and this provisional application is assigned to the same assignee as the present patent application.

### FIELD

At least some embodiments as described herein relate generally to control parameters of distribution of media content.

### COPYRIGHT NOTICE

The present description includes material protected by copyrights, such as illustrations of graphical user interface images. The owners of the copyrights, including the assignee, hereby reserve their rights, including copyright, in these materials. The copyright owner has no objection to the facsimile reproduction by anyone of the patent document or the patent disclosure, as it appears in the patent and trademark office file or records, but otherwise reserves all copyrights whatsoever. Copyright Digital Keystone, Inc. 2012.

### BACKGROUND

Advances in multimedia technology provide multiple ways to deliver linear or on-demand multimedia content to a user device. Traditionally, broadcast TV, video on demand (VOD) or near video on demand (NVOD) are systems, which allow users to select and watch/listen to multimedia content on a television set, over a one or two-way broadcast network using a network abstraction device, such as a set-top box.

Internet television, using the Internet, does not require a network abstraction device, and is increasingly becoming a popular form of video on demand. Some video distribution systems, for example, the video distribution system provided by Netflix, Inc., located in Los Gatos, Calif., provide on-demand media over the Internet to multiple choices of modern subscriber devices.

As such, the multimedia content could be delivered to the subscriber over a variety of networks, including a) legacy broadcast networks (e.g., cable TV, satellite TV); b) managed IP networks operated by cable TV or IPTV operators such as Comcast and AT&T Uverse, c) Internet-based over the top (OTT) networks that utilize the Internet, such as Netflix and iTunes, or d) any combination of the above. Both managed IP networks and Internet-based OTT networks can utilize various edge-caching techniques to improve the ability to sustain a high volume of requests by subscribers.

Generally, legacy broadcast networks such as cable TV and IPTV networks, and IP networks that utilize edge caching are described as content delivery networks (CDN). A CDN can be public, if the network services are made available to multiple service providers, or private, if the services are made available only to one provider. Typically, CDN's that allow the selection of detailed transmission parameters are defined as “transparent” CDN's, while CDN's that do not allow the selection of detailed transmission parameters are defined as “opaque” CDN's.

Existing CDN video distribution systems require significant manual set-up and management operations to optimize the content distribution per asset to minimize the service provider operation cost and improve the customer experience. As an example, CDN's require manual provisioning of packaging and caching parameters per asset in order to respond to the need of distributing popular and less popular content items.

Additionally, CDN's do not automatically shut off when their caching capabilities are not required for some asset. Further, service providers than rely on multiple CDNs do not have the capability to automatically select the best CDN option per transaction.

### SUMMARY

Exemplary embodiments of methods and apparatuses to automatically control the distribution of media using one or more content distribution path options and/or parameters, involving one or more gateways are described. In at least some embodiments, a CDN Shaping Service (CSS) utilizes catalog optimization at a server to recommend one or more content distribution paths and/or content distribution parameters for each asset, based on the domain analytics data collected by a domain manager. A subscriber domain is defined as an association of at least one or more gateways, which support one or more content distribution paths.

In at least some embodiments, an asset has multiple events that are scheduled and recorded back-to-back. For example back-to-back events included in linear catch-up TV services can result in assets that span certain time intervals of one or more linear channels.

In at least some embodiments, the domain analytics data collection can be limited to the transactions that originate behind a specific edge caching server interface of a CDN. This narrow analytics data collection allows the CSS to optimize distribution for devices within a certain region of the network that is served by a specific edge-caching server.

In at least some embodiments, the domain analytics data collection can be limited to a period of time, representative of the relevant traffic. This narrow analytics data collection allows the CSS to optimize distribution with parameters that reflect content usage over a specific time period.

In at least some embodiments, the characteristics of the CDN's are taken into account to decide if one content distribution path is better suited to distribute an asset than another. If both options are eligible, the CDN characteristics can be used to define which content distribution path is attempted first. This content distribution path aware policy allows the CSS to optimize distribution according to at least one of cost, performance characteristics of each available CDN, and a user experience.

In at least some embodiments, an asset that is deemed available from both a home gateway and a network gateway is preferred to be retrieved from the home gateway in order to optimize network traffic load. In another embodiment, an asset that is deemed available from both a home gateway and a network gateway is preferred to be retrieved from the network gateway in order to optimize user experience.

In at least some embodiment, an asset that is available from a network gateway either via direct access to the origin cache or using a CDN is preferred to be retrieved directly, if the current asset popularity doesn't justify the cost of caching or CDN distribution.

In at least some embodiment, an asset is assessed to be available for playback from a given gateway when all the media content segments corresponding to that asset are discovered to be present on the attached origin cache.

In at least some embodiment, an asset is assessed to be available for playback from a given gateway when a sufficient number of media content segments corresponding to a portion of that asset are discovered to be present on the attached origin cache. In at least some embodiment, the sufficient number of available media content segments that cause an asset to be assessed available for playback can be less than the total number of segments comprising that asset, as the content segment creation is in progress at the time of playback.

In at least some embodiment, the sufficient number of available media content segments that cause an asset to be assessed available for playback can be none, as the media content segments are created dynamically on demand upon request.

In at least some embodiments, an asset requested from a home gateway, which is not currently available in the gateway origin cache can be generated based on availability of said asset from one or more upstream network gateways. Using a combination of sources optimizes the network traffic load and the user experience.

In at least one embodiment, a CDN feeds from a content origin that has been loaded up with content by a gateway. In at least one embodiment, a gateway and content origin feeds multiple CDNs. In another embodiment, a gateway ingests content from an upstream CDN. In at least some embodiments, multiple content distribution paths including a cascade of gateways and one or more CDNs are enabled.

In at least some embodiments, a network gateway provides content directly from its origin interface, via one or more edge-caching CDNs, or a combination thereof. In at least some embodiment, a home gateway ingests content from a broadcast CDN, network gateways, or a combination thereof. In at least some embodiments, a home gateway makes the content available to the home devices via any of its physical network interfaces (e.g. Ethernet, Wifi).

Other features as described herein will be apparent from the accompanying drawings and from the detailed description, which follows.

### BRIEF DESCRIPTION OF DRAWINGS

The embodiments as described herein are illustrated by way of example and not limitation in the figures of the accompanying drawings in which like references indicate similar elements.

FIG. 1 shows a block diagram illustrating an exemplary embodiment of a domain manager providing CSS over one or more CDN's and one or more gateways.

FIG. 2 shows an exemplary embodiment of domain association.

FIG. 3 shows an exemplary embodiment of content distribution path determination and edge caching server discovery.

FIG. 4 shows an exemplary embodiment of domain analytics data reception.

FIG. 5 shows an exemplary embodiment of optimized catalog generation.

FIG. 6 is a block diagram illustrating an exemplary embodiment of a subscriber domain.

FIG. 7 is a diagram illustrating an exemplary embodiment of a data structure containing domain analytics

FIG. 8 illustrates an exemplary embodiment of a database to record domain analytics.

FIG. 9 shows a flowchart of an exemplary embodiment of a method at a domain manager server to provide a CDN Shaping Service.

FIG. 10 shows a block diagram of one embodiment of a data processing system to provide a CDN Shaping Service.

### DETAILED DESCRIPTION

The embodiments will be described with references to numerous details set forth below, and the accompanying drawings. The following description and drawings are illustrative of the embodiments and are not to be construed as limiting. Numerous specific details are described to provide a thorough understanding of the embodiments as described herein. However, in certain instances, well known or conventional details are not described in order to not unnecessarily obscure the embodiments in detail.

Reference throughout the specification to “at least some embodiments”, “another embodiment”, or “an embodiment” means that a particular feature, structure, or characteristic described in connection with the embodiment is included in at least some embodiments as described herein. Thus, the appearance of the phrases “in at least some embodiments” or “in an embodiment” in various places throughout the specification are not necessarily all referring to the same embodiment. Furthermore, the particular features, structures, or characteristics may be combined in any suitable manner in one or more embodiments.

Exemplary embodiments of methods and apparatuses to utilize the domain management data collected at least in part according to the methods as described in the U.S. provisional patent application No. 61/565,876 and U.S. patent application Ser. No. 13/408,943 (Attorney docket number 6517P014) filed on Feb. 29, 2012 to automatically control the parameters of distribution of media content, over a plurality of content distribution paths, to a subscriber domain of devices.

In at least some embodiments, a method is defined to achieve a CDN shaping service, for example, to identify the most optimized distribution path of media content to a subscriber device both in terms of user experience and operation cost. A subscriber domain comprises an association of devices, content sources (gateways), entitled assets and domain rights, as defined in the U.S. provisional patent application No. 61/565,876. In at least some embodiments, a content distribution network is introduced, which can cache multiple copies of the asset at different levels of the network. The CDN can be, for example, opaque, transparent, or a combination thereof. The CDN can be managed, non-managed, or a combination thereof. In at least some embodiments, methods as described herein leverage network analytics as aggregated by a domain management system to define and control the operation and performance of one or more content distribution networks.

Generally, the objective of a content distribution network (CDN) is to deliver media assets to registered subscriber players at sufficient perceived quality and at the lowest possible cost. Typically, CDNs include both managed networks and non-managed (“best effort”) networks. Additionally, CDN feeds from an origin cache and can create additional copies in locations close to the subscriber device to mitigate access contention. Further, CDNs can be opaque (the CDN autonomously determines content flow) or transparent (the CDN allows for the content distributor to control certain aspects of the content path within the CDN). Media assets may include linear streams and on-demand files of video, music, games, and applications. Typically, optimized CDN topologies can be widely different for the most popular content (“Hits”) compared to less popular content (“Long Tail”). In at least some embodiments, the specifics of automated optimization of CDN policies derived from content analytics as determined by a domain management system are described herein. Automated optimization applies to the choice of a CDN (on a title-by-title or format-by-format basis). In case of a transparent CDN, optimization further affects the selection of content distribution parameters within a managed multi-stage CDN.

In at least some embodiments, controlling the cost and performance of content distribution is addressed. In at least some embodiments, domain analytics data are used to determine a cost-optimal distribution path. Without resorting to at least some embodiments as described herein, a service provider would need to develop, maintain and manually support a CDN management policy for the content distribution networks. Beyond the case of media content distribution to subscriber devices over a plurality of content distribution networks, applications of the embodiments as described herein include distribution of music, application and game assets via multiple distribution networks.

In at least some embodiment, an asset has multiple back-to-back recorded events. For example, linear catch-up TV services, which permanently record the last time interval of one or more linear channels, create an asset that includes all the TV event during that time interval.

In at least one embodiment, a CDN feeds from an origin that has been loaded up with content by a gateway. Typically, a gateway is at least one of a device and a server that is capable of generating content in a format that can be distributed by a CDN, and eventually rendered by a subscriber device. In at least one embodiment, a gateway and origin feeds multiple CDNs. In another embodiment, a gateway ingests content from an upstream CDN. In other words, embodiments described herein enable a multiple choice of content distribution paths, which can include a cascade of gateways and one or more CDNs. A network gateway can provide content directly from, for example, its origin interface, and via one or more edge-caching CDNs. A home gateway can ingest content from, for example, a broadcast CDN, and a network gateway. A home gateway can make the content available to the home devices via any of its physical network interfaces (e.g. Ethernet, Wifi).

In one embodiment, an asset can be distributed via complex distribution paths involving more than one gateways, or more than one CDNs.

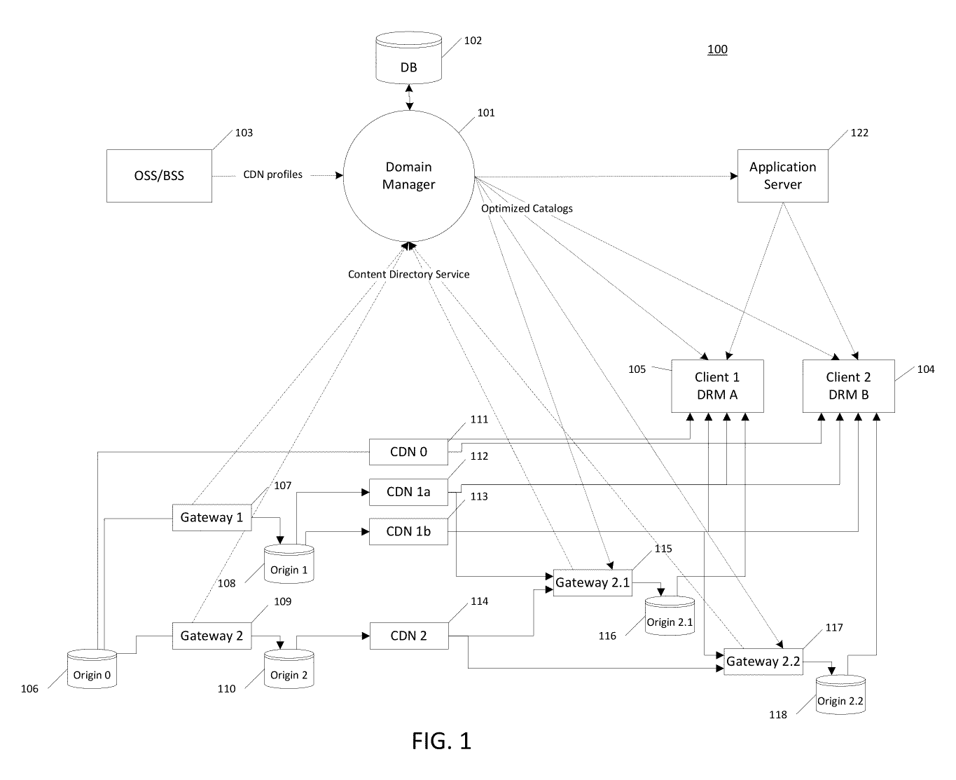

FIG. 1 shows a block diagram illustrating an exemplary embodiment of a domain manager network 100. As shown in FIG. 1, a domain manager (DM) server 101 is coupled to a database (DB) 102, an operation support system/business support system (OSS/BSS) 103, an application server 122, two subscriber client devices 104 and 105, and four gateways 107, 109, 115 and 117.

In at least some embodiments, DM server 101 is an on-line server providing domain management services for media content distribution. It is designed to abstract the ever growing complexity and multitude of subscriber client devices, while taking advantage of all the service provider's multiple content distribution networks.

In at least some embodiments, the DM server is configured with device profiles that allow selecting the best content format on a per-client player basis; domain rules that allow managing asset license authorizations per type, number and identity of client devices; and catalog rules that allow prioritizing content distribution network (CDN) policies on a per-asset basis. DM server is designed to equally handle the distribution of streaming video and music, and the file download of video, music, games and applications.

In at least some embodiments, the DM server indirectly controls the gateway packager to dynamically create a rich variety of secured content formats, to generate server trick modes on the fly, and to provide real-time playback sessions status. The DM server also operates with existing content preparation systems. In at least some embodiments, the DM server provides three types of domain management services:
Domain Navigation: this service facilitates the navigation of assets as available to each client device registered in the domain.
Domain Authorization: this service facilitates the control of the playback rights for assets available to the domain, based on asset and domain rules.
Domain Analytics: this service aggregates real-time information on the playback transactions in the domain with the purpose of managing the transactions across multiple devices and locations, measure the quality of experience, and allocate traffic across multiple distribution networks. In at least some embodiments, the DM server supports the simultaneous management of multiple service providers in total independence.

As shown in FIG. 1, OSS/BSS 103 provides CDN profiles data to DM 101. DM 101 receives content directory service (CDS) updates from a gateway 1 107, a gateway 2 109, a gateway 2.1 115 and a gateway 2.2 117, and provides optimized catalogs data to application server 122, a client 105, a client 104, and a gateway 2.1 115 and a gateway 2.2 117. In at least some embodiments, a subscriber domain includes different types of client devices that are made using different technologies. For example, client 105 can be an iPad, or Android tablet, and client 104 can be a television with a network connection (“smart” TV), or a personal computer, for example a PC, or Mac. The subscriber devices can be secured with different Digital Rights Management (“DRM”) systems. For example, client 105 can be secured by a DRM A, and client 104 can be secured by a DRM B.

As shown in FIG. 1, client 1 105 is connected to a content origin 0 106 via CDN 0 111, a content origin 1 108 created by a network gateway 1 107 via a CDN 1a 112 and a CDN 1b 113, and directly to a home content origin 2.1 116 created by a home gateway 2.1 115. The home gateway 2.1 115 processes content delivered by a broadcast CDN 2 114 out of a content origin 2 110 and an IP-based CDN 1.a 112. A content origin 2 110 is created by gateway 2 109 out of the initial content origin 0 106. As shown in FIG. 1, client 2 104 is connected to the same content origin 0 106 via CDN 0 111 as client 105. Client 2 104 is connected to content origin 1 108 created by a network gateway 107 using the same CDN 1a 112 and CDN 1b 113, but a different home origin 2.2 118 created by another home gateway 2.2 117, which feeds from a broadcast CDN 2 114 out of origin 2 110 and an IP-based CDN 1.b113. In at least some embodiments, all gateways are directly or indirectly coupled to the initial content origin 0 106 that includes all the referenced assets provided by an operator. In at least some embodiments, one or more content distribution paths for a subscriber domain involve a complex distribution path with more than one gateway and more than one CDN. In at least some embodiments, home gateways, 115 and 117, are indirectly coupled to a content origin, e.g., content origin 106 via a gateway 2 109 and a broadcast CDN 2 114, to minimize the number of requests to the origin. In at least some embodiments, the clients 104 and 105 access the content repository 106 through a broadcast CDN 2 114, and an IP based CDN 1.a 112 and 1.b113. Client 104 is coupled to a gateway 2.2 117 via a local IP network, while at home, and via Internet while roaming, providing that gateway 2.2 117 has a public IP address. As shown in FIG. 1, each of the clients 105 and 104 can be coupled to application server. In one embodiment, the application server contains an on-line application to browse media content. Systems and methods for navigating broadcast signals using an on-line navigation application are described in a U.S. patent application Ser. No. 12/228,665 entitled “DISTRIBUTED TV ACCESS SYSTEM” which is incorporated herein by reference in its entirety.

In at least some embodiments, a database (“DB”) coupled to the DM server, such as DB 102 stores information associated with the subscriber domains (e.g., data identifying the subscriber devices, playback positions, and other subscriber domain information). In at least some embodiments, a web application (not shown) coupled to the DM server and facing a service provider allows configuring, monitoring and analyzing the domain management activities, as described herein.

In at least some embodiments, DM 101 is a Maelstrom™ Domain Manager (MDM) server produced by Digital Keystone Inc., located in Mountain View, Calif.

In at least one embodiment, the DM server is designed to be scalable, and to integrate with the existing operator backend infrastructure. In at least some embodiments, the DM server includes one or more web services incorporating embodiments of methods as described herein to communicate with a OSS/BSS 103 and application server 122.

The home gateway (e.g. gateway 2.1 115, and gateway 2.2 117) can receive media content from for example, a cable, satellite, terrestrial, or an IPTV legacy CDN, and are coupled to a home origin to store content. The network gateway (e.g. gateway 107) can directly access one or more content origins. In at least some embodiments, a local IP network of the subscriber device is connected to a global IP network (e.g., Internet) through a router device (not shown).

In at least some embodiments, the subscriber devices 105 and 104 can include a player, which may be a software plug-in, a hardware decoder or a combination of both, for example, a Windows media player, a Flash media player, an iPod, a QuickTime media player, a RealTime media player, or any other video and/or audio player. The subscriber device can include an application program provided by the service provider or a browser to communicate with the application server 122.

In at least some embodiments, the application server in conjunction with the application program or the subscriber device browser, is configured to present a selection of media content to a user, for example, to find what to watch and to start playing the content. In at least some embodiments, the application server is further configured to receive playback control commands from a user, e.g., “play”, “fast forward”, “fast backward”, “jump”, “pause”, and the like, and to decide if that command needs to be sent to the player locally, needs to be sent to the gateway or a combination thereof.

In at least some embodiments, the DM server is configured to provide one or more of the following: domain association, device type identification, content distribution path determination, device registration, catalog adjustment, DRM license authorization, and domain monitoring, as described in the U.S. provisional patent application No. 61/565,876 and U.S. patent application Ser. No. 13/408,943 (Attorney docket number 6517P014) filed on Feb. 29, 2012.

In at least some embodiments, the content distribution options include a public transparent Internet Protocol CDN (CDN 0 111), a private transparent Internet Protocol based CDN (CDN 1a 112), or a private opaque Internet Protocol CDN (CDN 1.b113), a broadcast legacy content delivery network (CDN 2 114), a home private network (out of origin 2.1 116 or origin 2.2 118) or a combination thereof.

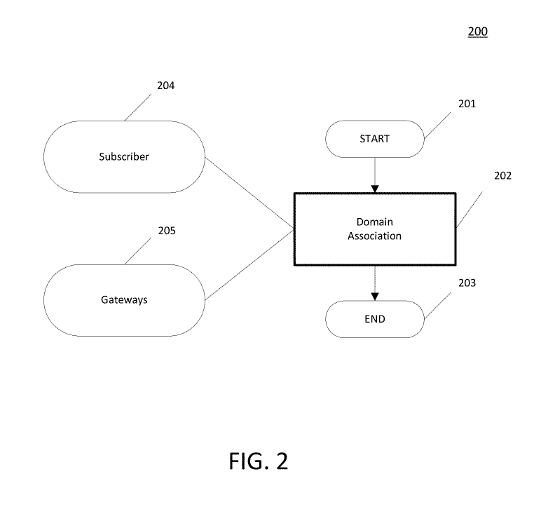

FIG. 2 shows an exemplary embodiment of the domain association. A domain association 200 starts at a block 201. At a block 202 one or more subscriber devices 204, and one or more gateways 205 are associated into a subscriber domain. In at least one embodiment, domain association data are stored in a DM database (not shown). Domain association 200 ends at a block 203.

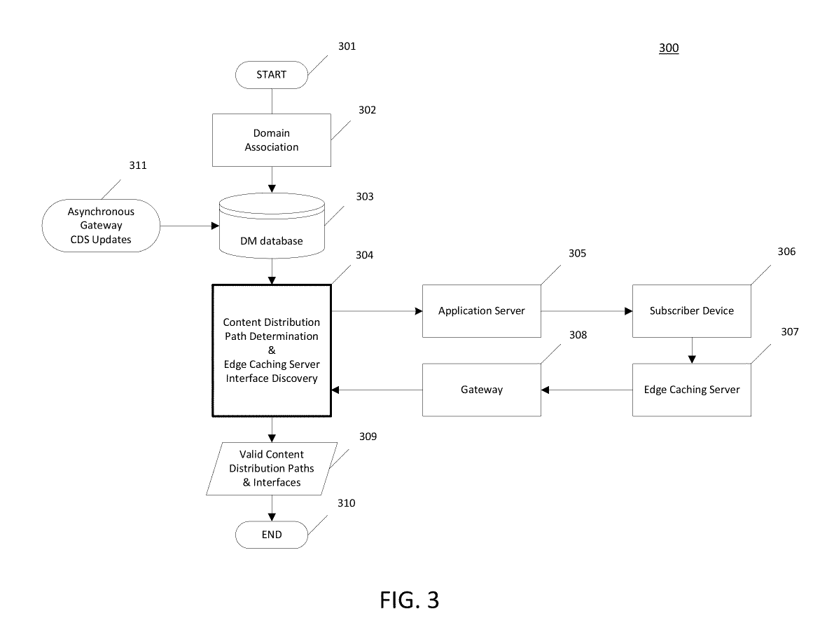

FIG. 3 shows an exemplary embodiment of the content distribution path determination and edge caching server discovery. A content distribution path determination 300 starts at a block 301. As shown in FIG. 3, domain association data 302 and asynchronous gateway content directory service (CDS) updates data 311 are stored in a DM database 303. That is, after domain association, gateways can upload asynchronously their catalog data to the DM. The gateway catalog data include the gateway content distribution path identifiers (e.g. URLs or IP addresses), and the list of assets and format that the gateway can provide. The gateway catalog data are stored in DM database 303. Upon connection with a subscriber device 306, DM provides a list of all the domain gateway content distribution path identifiers to an application server 305, which passes them to the subscriber device 306. In one embodiment, one or more content distribution paths to the associated gateways are determined, and an edge caching server interface of the content distribution paths that are selected for the subscriber device is discovered at a block 304 for example, by verifying that the gateway content distribution path identifiers are reachable by the subscriber device. In at least some embodiments, the edge caching server interface of the content distribution path is a subscriber device interface. When an edge caching server 307 is reached by a subscriber device 307, gateway 308 sends a report to DM. At a block 309 the one or more content distribution paths and interfaces are validated based on the report from gateway 308. Content distribution path determination ends at a block 310.

In at least some embodiment, determining one or more content distribution paths to the associated gateways for the subscriber device also involves localizing the subscriber device by the gateways, identifying the presence of an edge-caching server interface, or a combination thereof.

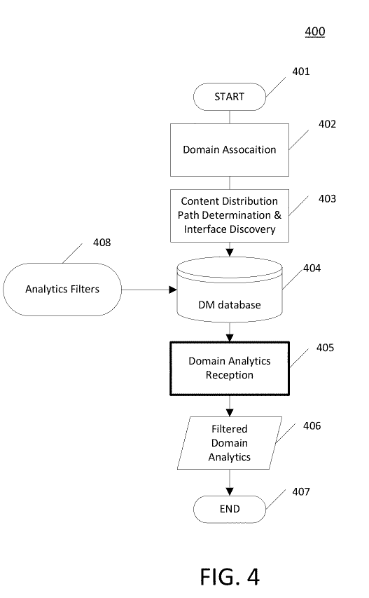

FIG. 4 shows an exemplary embodiment of domain analytics data reception. A domain analytics data reception 400 starts at a block 401. As shown in FIG. 4, domain association data 401, content distribution path determination and interface discovery data 403, and analytics filters 408 are stored in DM database 404. That is, domain association, content distribution path determination and interface discovery, and analytics filters are prerequisites to a domain analytics data reception 405. Domain analytics data reception ends at a block 407.

In at least some embodiments, the received domain analytics data are filtered according to the one or more assets available to the subscriber domain upon connection; the one or more assets available to the subscriber device upon connection; the same or similar assets requested by the subscriber device upon connection; the same or similar assets requested by an identical or similar device; the assets with same or similar contracts to those that apply to the requested asset; the assets with same or similar entitlements to those that apply to the requested asset; the transactions involving the discovered edge caching server for any asset; the transactions involving the discovered edge caching server for the same asset; the transactions involving the origin server for any asset; the transactions involving the origin server for the same asset; a relevant time interval; or any combination thereof.

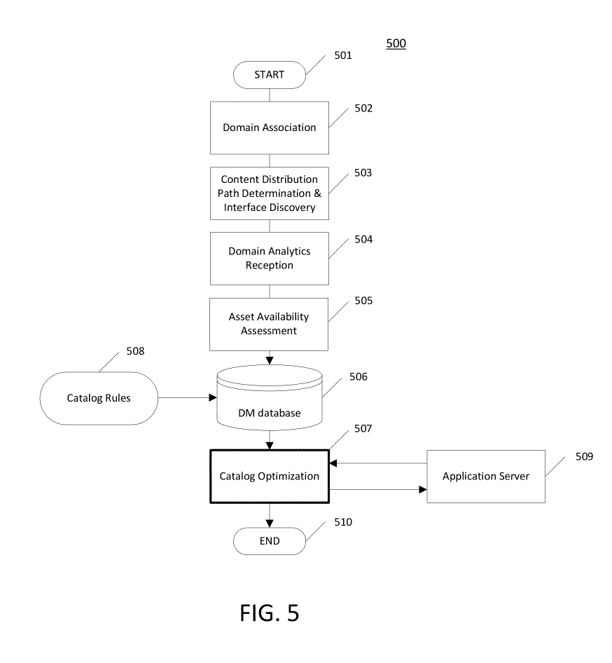

FIG. 5 shows an exemplary embodiment of optimized catalog generation. An optimized catalog generation 500 starts at a block 501. As shown in FIG. 5, domain association data 502, content distribution path determination and interface discovery data 503, domain analytics reception data 504, asset availability assessment data 505 and catalog rules 508 are stored in a DM database 506. That is, domain association, content distribution path determination and interface discovery, domain analytics reception, asset availability assessment, and catalog rules are prerequisites to a catalog optimization 507. In at least some embodiments, catalog rules 508 allow prioritizing content distribution network (CDN) policies on a per-asset basis.

Catalog optimization is requested by an application server 509. In response, the catalog is optimized at a block 507 based at least on one of the domain association data, content distribution path determination and interface discovery data, asset availability, and domain analytics reception data, and catalog rules. The optimized catalog is delivered to the application server 509. The optimized catalog generation ends at a block 510.

In at least some embodiments, the catalog of media content is optimized according to an availability of the media content in the one or more associated gateways; a processing capability of the one or more associated gateways; the characteristics of the gateway content distribution paths; asset availability; domain analytics; or any combination thereof. In at least some embodiments, the optimization of the catalog includes creating a subscriber device specific catalog for a connection by performing one or more of the following actions: removing any undesirable content distribution paths per asset based on the relative characteristics of the content distribution paths, and the applicable domain analytics; adding one or more applicable content distribution parameters per asset based on the relative characteristics of the content distribution paths, and the applicable domain analytics; sorting all available content distribution paths per asset based on the relative characteristics of the content distribution paths, and the applicable domain analytics. In at least some embodiments, the optimization of the catalog includes identifying at least one of a start time, and an end time for each of the events within an asset. In at least some embodiments, the optimization of the catalog includes adding a resume play position for each asset.

In at least some embodiments, providing of the optimized catalog is directed to the application server, the subscriber device, the provisioned gateways, or any combination hereof.

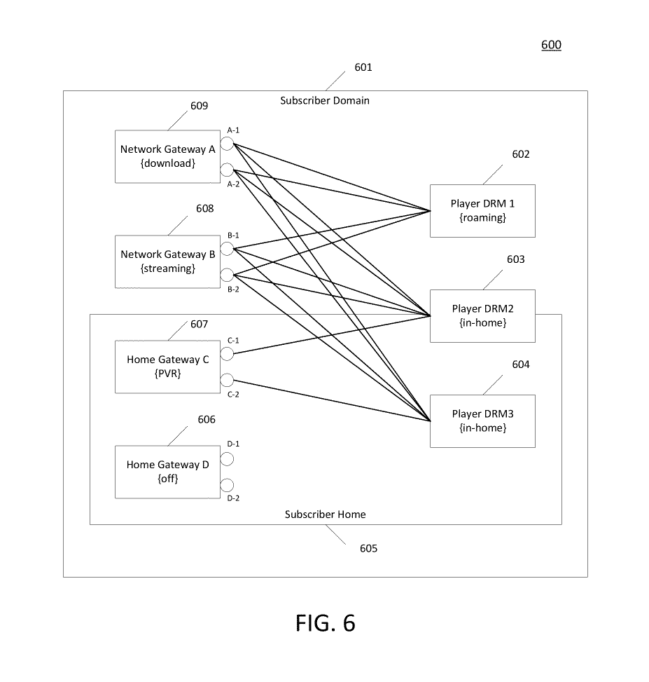

FIG. 6 is a block diagram illustrating an exemplary embodiment of a subscriber domain. In at least some embodiments, a subscriber domain, such as a subscriber domain 601, is defined as an association of: gateways (content sources), for example, network gateway(s) shared across subscriber domains, and home gateway(s) dedicated to an individual subscriber domain, client players device (content sinks), as registered with the domain by the subscriber, content entitlements, and domain rights. Each gateway can have multiple access points. In at least some embodiments, a network gateway has one origin URL and one or more CDN URLs. In at least some embodiments, a home gateway has one or more network interfaces. In at least some embodiments, gateways are provisioned to the subscriber domain by the service provider. In at least some embodiments, players include an approved DRM client. In at least some embodiments, how many players can be registered is defined by the domain rights associated to the domain by the service provider. In at least some embodiments, the content entitlements represent the rights of the domain to access certain content under certain policies (i.e. subscription, rental, purchase). In at least some embodiments, entitlements are associated with the domain by the service provider. In at least some embodiments, the domain rights define access to a certain level of domain boundaries, such as the maximum number of devices that can be registered, as defined by the service provider. In at least some embodiments, the DM server uses a cloud-assisted discovery process to determine, which content distribution options are available for each connected player.

As shown in FIG. 6, a subscriber domain 601 includes two home gateways, such as gateways 606 and 607 and two network gateways, such as gateways 608 and 609. The content distribution path determination method detects that gateway 606 is not reachable on any of its interface (e.g. turned off); a player 602 is roaming and can reach both network gateways on both of their interfaces, but cannot reach home gateway 607; a player 603 is at home and can reach both network gateways on both of their interfaces and home gateway 607 on one physical interface (e.g. Ethernet); a player 604 is also at home and can reach both network gateways on both of their interfaces and home gateway 607 on another physical interface (e.g. Wi-Fi). In at least some embodiments, the one or more gateways associated into the subscriber domain include one or more home gateways, one or more network gateways, or any combination thereof. In at least some embodiments, the DM server updates its domain navigation, authorization and analytics services every time it detects a topology change in the subscriber domain.

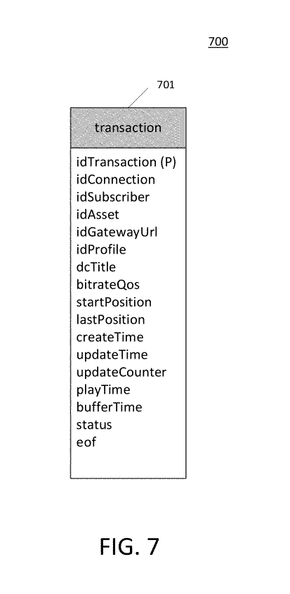

FIG. 7 is a diagram illustrating one exemplary embodiment of a data structure containing domain analytics. The table data structure 700 includes one record per device transaction. In one embodiment, a transaction record is created when a license authorization is requested. In another embodiment, a transaction is created upon a reception of a playback update for a transaction that doesn't have yet a record (e.g. clear content).

In at least some embodiments, a transaction record 701 includes a transaction identifier (idTransaction (P)), a connection identifier (idConnection), a subscriber identifier (idSubscriber), an asset identifier (idAsset), a gateway URL identifier (idGatewayUrl), a profile identifier (idProfile), and one or more other parameters. In some embodiments, the other parameters include an optional dcTitle value to identify user content, a playback position when the transaction is created (startPosition), a playback position when the transaction is updated (lastPosition), a time when the transaction record is created (createTime), a time when the transaction record is last updated (updateTime), a counter (updateCounter) that increases every time the transaction record is updated, an asset acquisition time (playTime), a total buffering time (bufferTime) to measure the aggregated time the playback operation has been interrupted for buffering, a transaction status (status) and a end-of-file flag (eof). In another embodiment, a streaming quality QoS parameter (bitrateQoS) represents the bitrate usage distribution over the period of the transaction (lastPosition-startPosition).

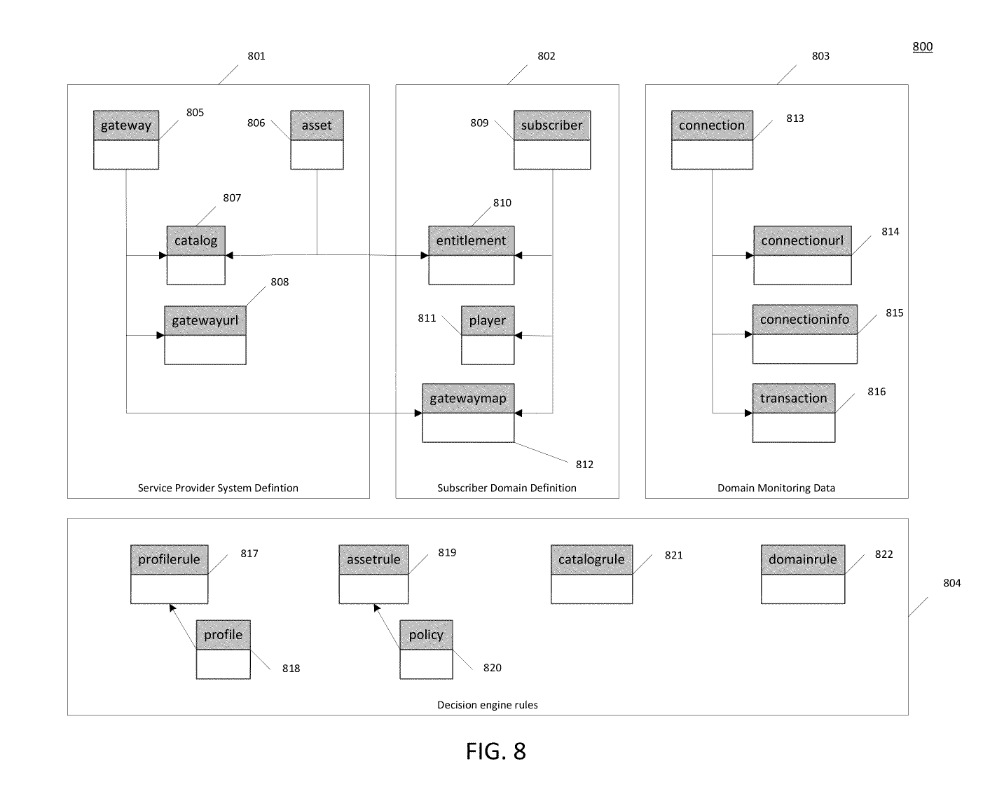

FIG. 8 illustrates an exemplary embodiment a database 800 to record domain analytics. The idConnection identifier, e.g., the id Connection identifier depicted in FIG. 7, is a pointer to a connection 813 table and related connectionurl 814 and connectioninfo 816 tables. A connection record is created every time a subscriber device performs a domain discovery sequence, as described above. The idSubscriber, e.g., the idSubscriber depicted in FIG. 7 is a pointer to a subscriber 809 table and related entitlement 810, player 811 and gatewaymap 812 tables.

The subscriber and dependent tables store the result of the domain association method. The idAsset, e.g., the idAsset depicted in FIG. 7, is a pointer to an asset 801 table and a related catalog 807 table. The asset and catalog tables are used to generate the adjusted catalog. The idGatewayUrl, e.g., the idGatewayUrl depicted in FIG. 7, is a pointer to a gatewayurl 808 table and a related gateway 805 table. The gatewayurl table has one record per gateway content distribution path identifier; the gateway table has one record per gateway. The idProfile e.g., the idProfile depicted in FIG. 7, is a pointer to a profile 818 table. The profile table has one record per supported format. That is, a transaction uniquely identifies a unit of media content as a combination of an asset and a profile. Other tables include a profilerule 817 table to define how a subscriber device is identified, an assetrule 819 table to partially define how a license request is authorized, a catalogrule 821 table to define how an adjusted catalog is created, a domainrule 822 table to define how a device is registered. In one embodiment, a policy 820 table is defined to update the rights of the authorized DRM license.

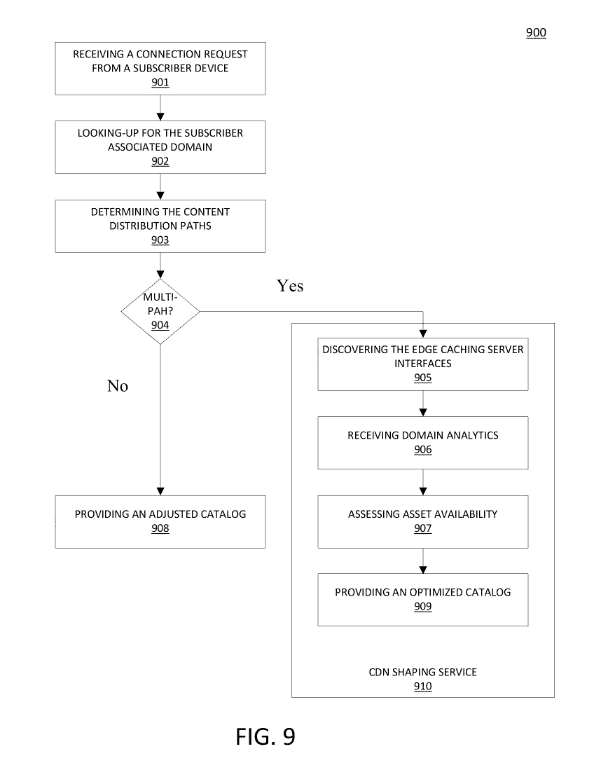

FIG. 9 shows a flowchart of an exemplary embodiment of a method 900 at a domain manager server to provide a CDN Shaping Service. Method 900 begins with operation 901 that involves receiving a connection request from a subscriber device. In at least some embodiments, the request is received from an application server, e.g., application server 112. In at least some embodiments, the request is received directly from a subscriber device (e.g., client device 104, or client device 105). At operation 902, the domain associated to the subscriber is looked up. At operation 903 the content distribution paths for the connection are determined. At operation 904 a determination is made if there are multiple content distribution paths available for the connection. If there are no multiple content distribution paths available for the connection, an adjusted catalog for the connection is provided at operation 908. If there are multiple content distribution paths available for the connection, a CDN shaping service 910 is performed. In at least some embodiments, CDN shaping service 910 involves discovering the edge caching server interfaces at operation 905, receiving applicable domain analytics data based on the discovering at operation 906, and assessing the availability of the assets at operation 907. Receiving the domain analytics data can involve a variety of actions. In at least one embodiment, receiving the domain analytics data involves actively collecting by the domain manager the domain analytics data over a period of time. In at least one embodiment, receiving the domain analytics data involves obtaining the domain analytics data from another system that has collected the data over a period of time. In at least one embodiment, assessing the asset availability involves discovering the number of segments already present in the gateway origin and identifying the start and end time of each event within the asset. At operation 909 an optimized catalog is created based, at least in part, on the received domain analytics. In at least some embodiments, the optimized catalog is provided to a navigation application rendered on the subscriber device.

### Domain Navigation

In at least some embodiments, the DM server delivers a content catalog carrying format, distribution, and rights details to the application server of the service provider. It facilitates the navigation of large media content collections by generating a different catalog for each connection that includes asset references in a format optimized for each subscriber device.

When multiple distribution options are available, an optimal route is selected based on catalog rules defined by the service provider and real-time domain analytics (e.g., CDN Shaping Service 910). For example, in order to minimize network traffic, higher priority could be given to an asset available in a home gateway rather than to the same asset from a network gateway; or an obscure B-movie could be directly retrieved from the network gateway's origin URL bypassing the CDN cache mechanisms to minimize distribution costs. In at least some embodiments, domain navigation features include one or more of the following:
1. Selecting the playable assets address based on player characteristics, location and domain definition;
2. Support multi-protocol adaptive streaming of video, music and game titles;
3. Support multi-protocol download of video, music, game, and application titles;
4. Selecting optimized formats for each player based on a centralized device profile library;
5. Selecting optimized distribution options based on CDN characteristics, asset availability and domain analytics;
6. Enabling users to pause any playback session on any player from any gateway and resume on any other player from any other gateway;
7. Enabling scrub-bar and trick mode navigation on all connections;
8. Providing navigation error codes for the application.

### Domain Authorization

In at least some embodiments, the DM server is responsible for authorizing the delivery of DRM licenses to the players. Multiple heterogeneous DRM license servers are supported. Decisions are made based on the integrity of the request, the type and location of the player, the domain entitlements and rights, and on the requirement that only registered players can access domain content. Domain registration occurs upon the initial play request. In at least some embodiments, this is mostly an automatic process, which only requires confirmation from the user. MDM enables the application to create a user-friendly player registration and deregistration experience.

In at least some embodiments, the domain authorization features include one or more of the following:

1. Restricting access only to players and assets that are properly authenticated;
2. Allowing the application to register, manage and unregister a player;
3. Restricting access only to players that are registered in the same domain as the gateway that provides the content (block unknown players);
4. Allowing the operator to define location-dependent per-domain content entitlement policies;
5. Allowing the operator to limit the number of simultaneous connections for each domain;
6. Restricting access to subscribed assets (block non-subscribers);
7. Restricting access to a maximum number of players in the domain;
8. Allowing the operator to define playback rights for asset classes on a per-approved DRM basis; and
9. Providing authorization error codes for the application.

### Domain Analytics

In at least some embodiments, the DM server maintains a real-time record of all the domain transactions to perform detailed domain analytics. The objective is to record enough information to be able to analyze the transactions per player type, location, and distribution options, to enable and maintain seamless multi-device sessions (pause and resume), and to measure the quality of the subscriber experience. Customizable Domain Analytics views are available through the DM server monitoring application. Third-party analytics tools can also be employed based on the collected data. The DM server is continuously using its own analytics data to optimize content distribution options in real-time.

Domain Analytics features include one or more of the following:

1. Tracking all asset playback sessions by player, by domain, by asset, by distribution path including the identification of the edge server, if any, and by format;
2. Monitoring all asset playback sessions with real-time start and end positions;
3. Monitoring the quality of service of all asset playback sessions;
4. Aggregating statistics on the number of players per domain;
5. Aggregating statistics on the type of players across domains;
6. Generating real-time statistics on asset consumption across domains;
7. Generating real-time statistics on asset consumption across players;
8. Generating real-time play count Lorenz distributions for each asset, in each format at each bitrate;
9. Generating real-time play duration Lorenz distributions for each asset in each format at each bitrate; and
10. Generating real-time play time and buffer time distribution charts.
11. Qualifying charts by domain, by entitled asset, by asset class, by asset container, by player, by played asset, and by time window.

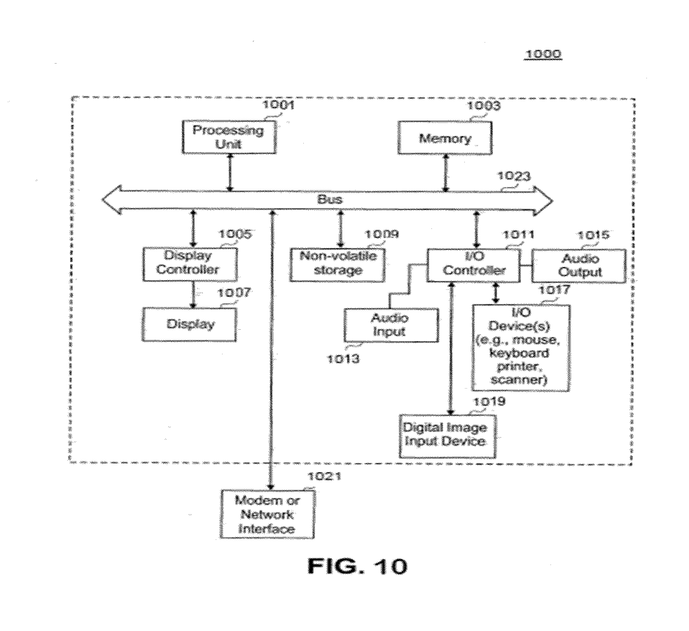

FIG. 10 shows a block diagram of one embodiment of a data processing system to provide a CDN Shaping Service. Data processing system 1000 includes a processing unit 1001 that may include a microprocessor or microprocessor, such as Intel microprocessor (e.g., Core i7, Core 2 Duo, Core 2 Quad, Atom), Sun Microsystems microprocessor (e.g., SPARC), IBM microprocessor (e.g., IBM 750), Motorola microprocessor (e.g., Motorola 68000), Advanced Micro Devices (“AMD”) microprocessor, Texas Instrument microcontroller, and any other microprocessor or microcontroller.

Processing unit 1001 may include a personal computer (PC), such as a Macintosh® (from Apple Inc. of Cupertino, Calif.), Windows®-based PC (from Microsoft Corporation of Redmond, Wash.), or one of a wide variety of hardware platforms that run the UNIX operating system or other operating systems. In at least some embodiments, processing unit 1001 includes a general purpose or specific purpose data processing system based on Intel, AMD, Motorola, IBM, Sun Microsystems, IBM processor families, or any other processor families. As shown in FIG. 10, memory 1003 is coupled to the processing unit 1001 by a bus 1023.

Memory 1003 can be dynamic random access memory (DRAM) and can also include static random access memory (SRAM). A bus 1023 couples processing unit 1001 to the memory 1003 and also to non-volatile storage 1009 and to display controller 1005 (if a display is used) and to the input/output (I/O) controller(s) 1011. Display controller 1005 controls in the conventional manner a display on a display device 1007 which can be a cathode ray tube (CRT), liquid crystal display (LCD), or any other display device. The input/output devices 1017 can include a keyboard, disk drives, printers, a scanner, a camera, and other input and output devices, including a mouse or other pointing device. The I/O controller 1011 is coupled to one or more audio input devices 1013, for example, one or more microphones.

The display controller 1005 and the I/O controller 1011 can be implemented with conventional well-known technology. An audio output 1015, for example, one or more speakers may be coupled to an I/O controller 1011. The non-volatile storage 1009 is often a magnetic hard disk, an optical disk, or another form of storage for large amounts of data. Some of this data is often written, by a direct memory access process, into memory 1003 during execution of software in the data processing system 1000 to perform methods described herein.

One of skilled in the art will immediately recognize that the terms “computer-readable medium” and “machine-readable medium” include any type of storage device that is accessible by the processing unit 1001. A data processing system 1000 can interface to external systems through a modem or network interface 1021. It will be appreciated that the modem or network interface 1021 can be considered to be part of the data processing system 1000. This interface 1021 can be an analog modem, ISDN modem, cable modem, token ring interface, satellite transmission interface, or other interfaces for coupling a data processing system to other data processing systems.

It will be appreciated that data processing system 1000 is one example of many possible data processing systems, which have different architectures. For example, personal computers based on an Intel microprocessor often have multiple buses, one of which can be an input/output (I/O) bus for the peripherals and one that directly connects the processing unit 1001 and the memory 1003 (often referred to as a memory bus). The buses are connected together through bridge components that perform any necessary translation due to differing bus protocols.

Network computers are another type of data processing system that can be used with the embodiments as described herein. Network computers do not usually include a hard disk or other mass storage, and the executable programs are loaded from a network connection into the memory 1003 for execution by the processing unit 1001. A typical data processing system will usually include at least a processor, memory, and a bus coupling the memory to the processor.

It will also be appreciated that the data processing system 1000 can be controlled by operating system software, which includes a file management system, such as a disk operating system, which is part of the operating system software. Operating system software can be the family of operating systems known as Macintosh® Operating System (Mac OS®) or Mac OS X® from Apple Inc. of Cupertino, Calif., or the family of operating systems known as Windows® from Microsoft Corporation of Redmond, Wash., and their associated file management systems. The file management system is typically stored in the non-volatile storage 1009 and causes the processing unit 1001 to execute the various acts required by the operating system to input and output data and to store data in memory, including storing files on the non-volatile storage 1009.

In various embodiments, hardwired circuitry may be used in combination with software instructions to implement methods described herein. A machine readable medium can be used to store software and data which when executed by a data processing system causes the system to perform various methods described herein. This executable software and data may be stored in various places including for example ROM, volatile RAM, non-volatile memory, and/or cache. Portions of this software and/or data may be stored in any one of these storage devices.

Thus, a machine readable medium includes any mechanism that provides (i.e., stores and/or transmits) information in a form accessible by a machine (e.g., a computer, network device, or any device with a set of one or more processors, etc.). For example, a machine readable medium includes recordable/non-recordable media (e.g., read only memory (ROM); random access memory (RAM); magnetic disk storage media; optical storage media; flash memory devices; and the like.

The methods as described herein can be implemented using dedicated hardware (e.g., using Field Programmable Gate Arrays, or Application Specific Integrated Circuit) or shared circuitry (e.g., microprocessors or microcontrollers under control of program instructions stored in a machine readable medium. The methods as described herein can also be implemented as computer instructions for execution on a data processing system, such as system 1000 of FIG. 10.

In the foregoing specification, embodiments as described herein have been described with reference to specific exemplary embodiments thereof. It will be evident that various modifications may be made thereto without departing from the broader spirit and scope of the embodiments as described herein. The specification and drawings are, accordingly, to be regarded in an illustrative sense rather than a restrictive sense.

What is claimed is:

1. A method at a server to control the distribution of media content to a subscriber domain, comprising:
(1) associating one or more gateways to the subscriber domain;
(2) determining one or more content distribution paths to the associated gateways for a subscriber device;
(3) discovering an edge caching server interface of the content distribution paths that are selected for the subscriber device;
(4) assessing an availability for playback of the media content at the associated gateways;
(5) receiving an applicable domain analytics;
(6) creating an optimized catalog of the media content based on (1) the associating; (2) the determining; (3) the discovering, (4) the assessing and (5) the receiving; and
(7) providing the optimized catalog to a navigation application rendered on the subscriber device.

2. A method as in claim 1, wherein the associated one or more gateways includes one or more home gateways, one or more network gateways, or any combination thereof.

3. A method as in claim 1, wherein the determined one or more content distribution paths include a broadcast legacy content delivery network (CDN), a private transparent Internet Protocol based CDN, a public transparent Internet Protocol based CDN, a private opaque Internet Protocol based CDN, a public opaque Internet Protocol based CDN, a home private network or a combination thereof.

4. A method as in claim 1, wherein the edge caching server interface of the content distribution path is the subscriber device interface.

5. A method as in claim 1, wherein assessing the availability of the media content includes discovering a number of segments already present in the gateway origin and identifying a start time and an end time of each event within an asset.

6. A method as in claim 1, wherein the receiving of the domain analytics is filtered according to one or more assets available to the subscriber domain upon connection;
the one or more assets available to the subscriber device upon connection;
the same or similar assets requested by the subscriber device upon connection;
the same or similar assets requested by an identical or similar device;
the assets with same or similar contracts to those that apply to a requested asset;
the assets with same or similar entitlements to those that apply to the requested asset;
transactions involving the discovered edge caching server for any asset;
the transactions involving the discovered edge caching server for the same asset;
the transactions involving the origin cache for any asset;
the transactions involving the origin cache for the same asset;
a relevant time interval; or
any combination thereof.

7. A method as in claim 1, wherein the catalog of media content is optimized according to
an availability of the media content from one or more associated gateways;
an availability of a subset or the entirety of the media content in an origin cache of the associated gateways;
a processing capability of the one or more associated gateways;
characteristics of the gateway content distribution paths;
domain analytics; or
any combination thereof.

8. A method of claim 7, wherein the optimization of the catalog includes creating a subscriber device specific catalog for a connection by performing one or more of the following actions
removing any undesirable content distribution paths per asset based on the relative characteristics of the content distribution paths, and the applicable domain analytics;
adding one or more applicable content distribution parameters per asset based on the relative characteristics of the content distribution paths, and the applicable domain analytics;
sorting all available content distribution paths per asset based on the relative characteristics of the content distribution paths, and the applicable domain analytics;
defining a start position and an end position of each event within an asset; and
adding a resume play position for each asset.

9. A method of claim 1, wherein the providing of the optimized catalog is directed to the application server, the selected gateways, the selected CDNs, the subscriber device, or any combination thereof.

10. A method as in claim 1, wherein changes of the subscriber domain triggers an update of the optimized catalog.

11. A method as in claim 1, wherein the content distribution paths comprise a complex distribution path including more than one gateway or more than one CDN.

12. A non-transitory machine-readable medium storing executable program instructions which when executed by a data processing system cause the system to perform a method to control the distribution of media content to a subscriber domain, comprising:
(1) associating one or more gateways, to the subscriber domain;
(2) determining one or more content distribution paths to the associated gateways for a subscriber device;
(3) discovering an edge caching server interface of the content distribution paths that are selected for the subscriber device;
(4) assessing an availability for playback of the media content at the associated gateways;
(5) receiving an applicable domain analytics;
(6) creating an optimized catalog of media content based on (1) the associating; (2) the determining, (3) the discovering, (4) the assessing, and (5) the receiving; and
(7) providing the optimized catalog to a navigation application rendered on the subscriber device.

13. A non-transitory machine-readable medium as in claim 12, wherein the associated one or more gateways includes one or more home gateways, one or more network gateways, or any combination thereof.

14. A non-transitory machine-readable medium as in claim 12, wherein the determined one or more content distribution paths include a broadcast legacy CDN, a private or public transparent Internet Protocol based CDN, a private or public opaque Internet Protocol based CDN, a home private network or a combination thereof.

15. A non-transitory machine-readable medium as in claim 12, wherein the edge caching server interface of the content distribution path is the subscriber device interface.

16. A non-transitory machine-readable medium as in claim 12, wherein assessing the availability of the media content includes discovering a number of segments already present in the gateway origin and identifying a start time and an end time of each event within an asset.

17. A non-transitory machine-readable medium as in claim 12,
wherein the receiving of the domain analytics is filtered according to
the one or more assets available to the subscriber domain upon connection;
the one or more assets available to the subscriber device upon connection;
the same or similar assets requested by the subscriber device upon connection;
the same or similar assets requested by an identical or similar device;
the assets with same or similar contracts to those that apply to a requested asset;
the assets with same or similar entitlements to those that apply to the requested asset;
transactions involving the discovered edge caching server for any asset;
the transactions involving the discovered edge caching server for the same asset;
the transactions involving the origin server for any asset;
the transactions involving the origin server for the same asset;
a relevant time interval; or
any combination thereof.

18. A non-transitory machine-readable medium as in claim 12, wherein the catalog of media content is optimized according to
an availability of the media content from one or more associated gateways;
an availability of a subset or the entirety of the media content in an origin cache of the associated gateways;
a processing capability of the one or more associated gateways;
characteristics of the gateway content distribution paths;
domain analytics; or
any combination thereof.

19. A non-transitory machine-readable medium as in claim 18, wherein the optimization of the catalog includes creating a subscriber device specific catalog for a connection by performing one or more of the following actions:
removing any undesirable content distribution paths per asset based on the relative characteristics of the content distribution paths, and the applicable domain analytics;
adding one or more applicable content distribution parameters per asset based on the relative characteristics of the content distribution paths, and the applicable domain analytics;
sorting all available content distribution paths per asset based on the relative characteristics of the content distribution paths, and the applicable domain analytics;
defining a start position and an end position of each event within an asset; and
adding a resume play position for each asset.

20. A non-transitory machine-readable medium as in claim 12, wherein the providing of the optimized catalog is directed to the application server, the selected gateways, the selected CDNs, the subscriber device, or any combination thereof.

21. A non-transitory machine-readable medium as in claim 12, wherein changes of the subscriber domain trigger an update of the optimized catalog.

22. A non-transitory machine-readable medium as in claim 12, wherein the content distribution paths comprise a complex distribution path including more than one gateway or more than one CDN.

23. A data processing system to control the distribution of media content to a subscriber domain, comprising:
means for (1) associating one or more gateways to the subscriber domain;
means for (2) determining one or more content distribution paths to the associated gateways for a subscriber device;
means for (3) discovering an edge caching server interface of the content distribution paths that are selected for the subscriber device;
means for (4) assessing the availability for playback of media content at the associated gateways;
means for (5) receiving an applicable domain analytics;
means for (6) creating an optimized catalog of media content based on (1) the associating; (2) the determining, (3) the discovering, (4) the assessing, and (5) the receiving; and
means for (7) providing the optimized catalog to a navigation application rendered on the subscriber device.

24. A method to control the distribution of media content to a subscriber domain, comprising:
receiving domain analytics data;
optimizing one or more content distribution options for an asset for a subscriber device based at least in part on the domain analytics data; and
selecting one or more content distribution paths to domain gateways for the subscriber device based on the optimizing.

25. The method of claim 24, further comprising
defining a start position and an end position of each event within the asset; and
adding a resume play position for the asset.

26. The method of claim 24, wherein the one or more content distribution paths comprise a complex distribution path including more than one gateway or more than one content delivery network (CDN).

27. The method of claim 24, wherein the optimizing is further based on at least one of
an availability of the media content from one or more associated gateways;
an availability of a subset or the entirety of the media content in an origin cache of the associated gateways;
a processing capability of the one or more associated gateways; and
characteristics of the gateway content distribution paths.

28. The method of claim 24, wherein the domain analytics is filtered based on
at least one of
one or more assets available to the subscriber domain upon connection;
the one or more assets available to the subscriber device upon connection;
the same or similar assets requested by the subscriber device upon connection;
the same or similar assets requested by an identical or similar device;
the assets with same or similar contracts to those that apply to a requested asset;
the assets with same or similar entitlements to those that apply to the requested asset;
transactions involving the discovered edge caching server for any asset;
the transactions involving the discovered edge caching server for the same asset;
the transactions involving the origin cache for any asset;
the transactions involving the origin cache for the same asset; and
a relevant time interval.

29. A non-transitory machine-readable medium storing executable program instructions which when executed by a data processing system cause the system to perform a method to control the distribution of media content to a subscriber domain, comprising:
receiving domain analytics data;
optimizing one or more content distribution options for an asset for a subscriber device based at least in part on the domain analytics data; and
selecting one or more content distribution paths to domain gateways for the subscriber device based on the optimizing.

30. The non-transitory machine-readable medium of claim 29, further comprising instructions that cause the data processing system to perform operations comprising
defining a start position and an end position of each event within the asset; and
adding a resume play position for the asset.

31. The non-transitory machine-readable medium of claim 29, wherein the one or more content distribution paths comprise a complex distribution path including more than one gateway or more than one content delivery network (CDN).

32. The non-transitory machine-readable medium of claim 29, wherein the optimizing is further based on at least one of
an availability of the media content from one or more associated gateways;
an availability of a subset or the entirety of the media content in an origin cache of the associated gateways;
a processing capability of the one or more associated gateways; and
characteristics of the gateway content distribution paths.

33. The non-transitory machine-readable medium of claim 29, wherein the domain analytics is filtered based on
at least one of
one or more assets available to the subscriber domain upon connection;
the one or more assets available to the subscriber device upon connection;
the same or similar assets requested by the subscriber device upon connection;
the same or similar assets requested by an identical or similar device;
the assets with same or similar contracts to those that apply to a requested asset;
the assets with same or similar entitlements to those that apply to the requested asset;
transactions involving the discovered edge caching server for any asset;
the transactions involving the discovered edge caching server for the same asset;
the transactions involving the origin cache for any asset;
the transactions involving the origin cache for the same asset; and
a relevant time interval.

34. A data processing system to control the distribution of media content to a subscriber domain, comprising:
means for receiving domain analytics data;
means for optimizing one or more content distribution options for an asset for a subscriber device based at least in part on the domain analytics data; and
means for selecting one or more content distribution paths to domain gateways for the subscriber device based on the optimizing.

35. The data processing system of claim 34, further comprising
means for defining a start position and an end position of each event within the asset; and
means for adding a resume play position for the asset.
